(19) United States
(12) Patent Application Publication
(10) Pub. No.: US 2009/0127118 A1
(43) Pub. Date: May 21, 2009

(54) SAMPLE SEPARATION/ADSORPTION APPLIANCE

(76) Inventors: Yutaka Unuma, Chiba (JP); Michinobu Mieda, Nara (JP); Yuji Maruo, Chiba (JP); Katsuyoshi Takahashi, Tokyo (JP)

Correspondence Address: NIXON & VANDERHYE, PC, 901 NORTH GLEBE ROAD, 11TH FLOOR, ARLINGTON, VA, 22203, US

(21) Appl. No.: 12/298,080

(22) PCT Filed: Apr. 18, 2007
(86) PCT No.: PCT/JP2007/058419

§ 371 Date: Oct. 22, 2008

(30) Foreign Application Priority Data
Apr. 25, 2006 (JP) 2006-121268

(51) Int. Cl. G01N 27/447; G01N 27/28

(52) U.S. Cl. 204/641

(57) ABSTRACT

A sample separation/adsorption appliance (100) includes: a first buffer solution tank (1) in which a first electrode (12) is to be disposed; a second buffer solution tank (2) in which a second electrode (22) is to be disposed; and a sample separating section (3) in which a separation medium (33) is to be contained. The sample separating section (3) has a first opening (31) opening into the first buffer solution tank (1) and a second opening (32) opening into the second buffer solution tank (2). The appliance (100) further includes second electrode fixing means (4) for disposing the second electrode (22) oppositely to the second opening (32). Preferably, the appliance (100) further includes adsorption member holding means (5) for holding an adsorption member (6) between the second opening (32) and the second electrode (22) to adsorb sample components which was discharged from the second opening (32) onto the adsorption member (6). This improves convenience of electrophoresis and western blotting, and specifically, automates steps from electrophoresis to electroblotting.

### TECHNICAL FIELD

The present invention relates to a sample separation appliance for separating a biological sample into individual components, more particularly, a sample separation/adsorption appliance for separating a sample and adsorbing the separated sample onto an adsorption member.

### BACKGROUND ART

After the human genome project was completed, the proteome has been vigorously researched. The “proteome” is the entire complement of proteins which are translated and produced in a specific cell and organ. An exemplary research of the proteome includes profiling of a protein.

The most popular technique for profiling a protein is electrophoresis of a protein, especially two-dimensional electrophoresis. A protein has a unique property according to electric charge and molecular weight thereof. Therefore, it is possible to separate a sample that is a mixture of a number of proteins into more number of proteins with a higher resolution when depending on a combination of electric charge and molecular weight than when depending on only electric charge or molecular weight.

A sample is separated into proteins according to electric charge and/or molecular weight of the proteins through electrophoresis. However, it is difficult to specify, from its separated position, a biological property of a protein separated according to such physical properties. Further, it is known that functions of proteins are controlled through chemical modification (post-translational modification) such as phosphorylation after synthesis of the proteins. It is difficult to obtain information about such post-translational modification only through electrophoresis.

Western blotting is a method for specifying proteins on the basis of antigen-antibody reaction by transferring, to a membrane, proteins in a slab gel that are separated through electrophoresis and overlaying a specific antibody on the proteins (for example, see Patent Document 1). In western blotting, the step of electrically transferring proteins from the slab gel to a membrane is called electroblotting. As for phosphorylation which is one of the post-translational modification, it is possible to detect whether or not there is phosphorylation and detect differences in phosphorylation sites by overlaying anti-phospho protein antibody to a membrane to which proteins were transferred.

As described above, a combination of electrophoresis and western blotting is very effective in specifying biochemical characteristics of proteins (for example, see Non-patent Document 1).

[Patent Document 1]

Japanese Unexamined Patent Application Publication Tokukaihei No. 7-63763 (published on Mar. 10, 1995)

[Non-Patent Document 1]

Protein experiment note (tanpakushitsu jikken note) vol. 2: from separation and identification to analysis of function (bunridoutei kara kinoukaiseki he) (Yodosya, 2005, pp 38-47)

### DISCLOSURE OF INVENTION

As for electrophoresis, speeding-up was attempted by miniaturization of gel, and simplification of operations was attempted by automatic devices. Especially, techniques concerning two-dimensional electrophoresis were remarkably improved. However, in electroblotting, it is necessary to take gels from an electrophoresis cassette after a sample is electrophoresed, and to cause the gels and a transfer membrane to be sandwiched by plane electrode, filter paper, transfer membrane, gel, filter paper, and another plane electrode in this order. Further, a voltage must be applied on them for a long time in an electrolyte solution. Therefore, automation of electroblotting was difficult.

Further, electrodes used in electroblotting are large in area, and the distance between the electrodes is short. Therefore, it is necessary to cause a high current (e.g. hundreds mA) to flow to the electrodes for a long time. Furthermore, there is a strong tendency for the largeness of electrode area to cause unevenness in an electric current at different parts of the electrode. This can create an area in which proteins are not sufficiently transferred from gels to a membrane. Furthermore, the same voltage is applied to the whole electrode for the same time. Therefore, it is difficult to transfer a high molecular weight component included in a sample, and a low molecular weight component tends to pass through the membrane after transfer. Naturally, in order to transfer a separated sample onto the membrane, a preparation time and an operation time for transfer are also required in addition to a time of electrophoresis needed for separation.

Western blotting is an excellent proteome analysis method. However, operation of electroblotting is complicated and requires a lot of experience. Therefore, automation and simplification of electroblotting were difficult.

The present invention has been attained in view of the above problems. An object of the present invention is to improve convenience of the electrophoresis and the western blotting, specifically, to achieve automation of a series of operations from electrophoresis to electroblotting.

A sample separation/adsorption appliance of the present invention includes a first buffer solution tank in which a first electrode is to be disposed, a second buffer solution tank in which a second electrode is to be disposed and a sample separating section in which a separation medium is to be contained, the sample separating section having a first opening which opens into the first buffer solution tank and a second opening which opens into the second buffer solution tank, the sample separation/adsorption appliance further including second electrode fixing means for disposing the second electrode oppositely to the second opening.

The sample separation/adsorption appliance of the present invention may further include adsorption member holding means for holding, between the second opening and the second electrode, an adsorption member for adsorbing sample components discharged from the second opening. As long as the adsorption member holding means functions to hold the adsorption member between the second opening and the second electrode, the present invention can be successfully carried out. That is, the adsorption member may be in contact with the second opening or the second electrode, or may have no contact with both of them. Further, all of the second opening, the adsorption member and the second electrode may be in contact with each other.

The sample separation/adsorption appliance of the present invention includes a first buffer solution tank, a second buffer solution tank and a sample separating section, the sample separating section having a first opening which opens into the first buffer solution tank and a second opening which opens into the second buffer solution tank and containing a separation medium via which a sample applied from the first opening is separated into individual components towards the second opening, the sample separation/adsorption appliance further including a first electrode disposed in the first buffer solution tank and a second electrode fixed oppositely to the second opening so as to be disposed in the second buffer solution tank.

The sample separation/adsorption appliance of the present invention may further include adsorption member holding means for holding, between the second opening and the second electrode, an adsorption member for adsorbing sample components discharged from the second opening.

In the present invention, when a voltage is applied to the first electrode and the second electrode, a sample applied to the first opening is separated into individual components in the sample separating section, and the separated sample is discharged from the second opening towards the second electrode and then is adsorbed onto the second electrode. Further, in a case where the sample separation/adsorption appliance further includes the adsorption member for adsorbing sample components, the separated sample components are discharged from the second opening towards the second electrode and then are adsorbed onto the absorption member.

In the sample separation by the conventional electrophoresis, a sample is separated in an electrophoretic medium according to the differences in electrophoretic velocity. The sample is moved in the electrophoretic medium, and application of a voltage is stopped before the separated sample components are discharged from the electrophoretic medium. In the conventional electroblotting, the adsorption member makes contact with the electrophoretic medium, and a voltage is applied vertically to the electrophoretic medium, so that the sample components distributed in the electrophoretic medium are transferred onto the adsorption member.

When the present invention has the above arrangement, the sample components separated in the separation medium of the sample separating section move through the separation medium from the first opening to the second opening. The second electrode provided for the separation and movement of the sample components is fixed oppositely to the second opening in the second buffer solution tank. Therefore, the separated sample components are discharged from the sample separating section (separation medium) to the second electrode via the second opening. Because the adsorption member for adsorbing the sample components is held between the second opening and the second electrode, it is possible to successfully adsorb the discharged sample components onto the second electrode. That is, the sample separation/adsorption appliance of the present invention is an appliance for successfully recovering the sample components discharged from the separation medium by using the voltage applied for electrophoresis.

It is preferable that the sample separation/adsorption appliance of the present invention further includes first driving means for moving the first buffer solution tank in a first direction defined by the first opening and the second opening.

With the above arrangement, the first buffer solution tank in which the sample separating section is fixed can be moved by the first driving means, and the distance between the second opening and the adsorption member (or the second electrode) can be successfully adjusted.

It is preferable that the sample separation/adsorption appliance of the present invention further includes second driving means for changing the relative position of the second opening and the second electrode (or the adsorption member) in a second direction vertical to the first direction defined by the first opening and the second opening.

With the above arrangement, by moving the adsorption member or the separation medium, it is possible to adsorb sample components to be discharged, one by one, onto a surface of the adsorption member.

In the sample separation/adsorption appliance of the present invention, the sample separating section may be disposed substantially vertically to a surface of a second buffer solution which fills the second buffer solution tank, or may be disposed substantially horizontally to the surface of the second buffer solution which fills the second buffer solution tank.

In a case where the sample separating section is disposed vertically to the surface of the second buffer solution which fills the second buffer solution tank, the second buffer solution tank to be filled with the second buffer solution is disposed horizontally, the second electrode is disposed on the bottom of the tank, the adsorption member is provided on the second electrode, and a sample separating section 3 is disposed substantially vertically to the adsorption member. The sample separating section 3 is composed of the separation medium and the sample separating section holding the separation medium. The second buffer solution tank is filled with the second buffer solution, the first buffer solution tank to be filled with the first buffer solution is disposed at a top end of the separation medium (i.e. at the first opening section of the sample separating section), and the sample is applied on the top surface of the separation medium. Next, the first electrode for applying a voltage is disposed in the first buffer solution tank, the second electrode for conducting electricity is disposed oppositely to a bottom end of the separation medium (i.e. to the second opening section of the sample separating section) in the second buffer solution tank. By applying a voltage to the first electrode and the second electrode, the sample is moved downward and is separated. At the same time, the relative position between parts where the bottom end of the separation medium (i.e. second opening section of the sample separating section) and the adsorption member face each other is changed. Thus, the sample components discharged from the bottom end of the separation medium (i.e. second opening section of the sample separating section) to the second electrode are adsorbed onto the adsorption member (or the second electrode) as patterns in accordance with the differences in the velocity in the electrophoretic medium.

In a case where the sample separating section is disposed horizontally to the surface of the second buffer solution which fills the second buffer solution tank, the first buffer solution tank to be filled with the first buffer solution is disposed at the first opening section of the sample separating section, the second buffer solution tank to be filled with the second buffer solution is disposed at the second opening section of the sample separating section, and the sample separating section is disposed in such a manner as to communicate between the first buffer solution tank and the second buffer solution tank. Next, the first electrode for applying a voltage is disposed in the first buffer solution tank, the second electrode for conducting electricity is disposed in the second buffer solution tank in such a manner as to face the second opening section of the sample separating section, and the adsorption member is disposed between the bottom end of the separation medium (i.e. second opening section of the sample separating section) and the second electrode. By applying a voltage to the first electrode and the second electrode, the sample is moved sideways (horizontally to the surface of the second buffer solution) and is separated. At the same time, the adsorption member facing the second opening section of the sample separating section is moved in a direction vertical to the first direction defined by the first opening and the second opening. Thus, the sample components discharged from the bottom end of the separation medium (i.e. second opening section of the sample separating section) to the second electrode are adsorbed onto the adsorption member (or the second electrode) as patterns in accordance with the differences in the velocity in the electrophoretic medium.

As described above, with the present invention, it is possible to perform successively the sample separation by the electrophoresis and the sample transfer (adsorption) by the western blotting as a series of operations.

In the sample separation/adsorption appliance of the present invention, the sample separating section in which the separation medium is to be contained preferably composed of two board insulators and spacers for defining the thickness of the separation medium contained between the two board insulators. Further, the sample separating section may be tapered from the first opening to the second opening.

With the above arrangement, the sample separating section of the present invention can be handled in a manner similar to a conventional slab gel.

In the sample separation/adsorption appliance of the present invention, when the second electrode is fixed oppositely to the second opening, and the second driving means changes the relative position between the second opening and the adsorption member by moving the adsorption member, it is preferable that the second electrode has the same shape as the second opening and has the same size as the second opening or smaller size than the second opening.

When the sample separating section has the above arrangement, it is preferable that the first opening and the second opening can take the shape of a rectangular, and the second electrode takes the shape of a rectangular, too. It is preferable that the second electrode has the same size as the second opening or smaller size than the second opening. For example, the second electrode can take the shape of a wire. In a case where the second electrode takes the shape of a wire, the second electrode is pushed against the rear surface of the adsorption member. Therefore, even if the adsorption member is moved, the position of the second electrode can be fixed in the vicinity of the end surface of the separation medium (i.e. the second opening). In this case, it is unnecessary to fix the second electrode in the second buffer solution tank, but it is necessary to always dispose the second electrode oppositely to the end surface of the separation medium (i.e. the second opening). Therefore, the second electrode fixing means may be formed so as to be integral with the sample separating section.

The second electrode for applying a voltage has a wire shape instead of a plane shape. This makes it easy for the second electrode to uniformly apply a voltage to a part where the sample is adsorbed (transferred), thereby making it possible to prevent the unevenness of the adsorption (transfer).

In the sample separation/adsorption appliance of the present invention, when the second driving means changes the relative position between the second opening and the second electrode (or the adsorption member), it is preferable that the second electrode has a plane shape and is fixed in the second buffer solution tank.

When the second electrode has a plane shape, and the relative position between the second opening and the second electrode (or the adsorption member) is changed by moving the adsorption member, the second electrode is disposed on the rear surface of the adsorption member and moves with the adsorption member. That is, the second driving means may serve as means for moving the second electrode or may serve as means for moving the adsorption member. Further, when the second electrode has a plane shape, and the relative position between the second opening and the second electrode (or the adsorption member) is changed by moving the sample separating section, it is unnecessary to move the second electrode and the adsorption member which are to be disposed in the second buffer solution tank.

In the sample separation/adsorption appliance of the present invention, when the second opening takes the shape of a rectangular, it is also preferable that the second electrode is divided into a plurality of stripe electrodes. In this case, it is preferable that the plurality of stripe electrodes are disposed in parallel to each other on an insulating substrate disposed oppositely to the second opening.

In the sample separation/adsorption appliance having the above arrangement, the plurality of stripe second electrodes do not move with respect to the adsorption member in the vicinity of the second opening. When the second driving means changes the relative position of the second opening and the plurality of second electrodes (or the adsorption member), the second electrode nearest to the second opening is replaced by another second electrode accordingly. This arrangement requires applying a voltage only to the second electrode nearest to the second opening. This makes it possible to separate/adsorb the sample with lower current, when compared to the case where a voltage is applied to the whole of the plane second electrode. It should be noted that the present arrangement requires arranging a switch so that a voltage is applied only to the target second electrode.

It should be noted that in the sample separation/adsorption appliance of the present invention, it is preferable that the adsorption member has a membrane shape.

In a case of using a membrane adsorption member, the whole appliance can be made more compact if the second driving means is arranged so as to unroll a rolled up adsorption member, and roll up the adsorption member after separation/adsorption.

It is preferable that the sample separation/adsorption appliance of the present invention further includes a control section for temporally controlling an applied voltage and the second driving means. It is more preferable that the control section controls depending on a current value between the first electrode and the second electrode.

For example, by monitoring a current value flowing through the separation medium, the control section controls the velocity of the adsorption member on the basis of the current value. Alternatively, the control section controls the velocity of the adsorption member by monitoring the velocity of a fluorescence-labeled marker molecule which was electrophoresed with a sample. In this case, it is preferable that the sample separation/adsorption appliance of the present invention further includes a light irradiation section and a fluorescence detection section.

By temporally controlling the velocity of the adsorption member, it is possible to change the adsorption pattern of the sample components. Further, it is possible to separately control the applied voltage and the velocity of the adsorption member. This makes it possible to control the applied voltage and the velocity of the adsorption member in accordance with the sample components discharged from the end surface of the separation medium. As a result, the low molecule weight sample components do not go through the adsorption member, and defective adsorption (transfer) of the high molecular weight sample components can be prevented.

It should be noted that in the sample separation/adsorption appliance of the present invention, a filter paper may be disposed between the adsorption member and the electrode in order to secure a good electrical connection between the adsorption member and the electrode.

A sample separation/adsorption method of the present invention is a method for separating a sample and adsorbing the sample onto an adsorption member by applying a voltage to a first electrode and a second electrode, the sample separation/adsorption method including the steps of: disposing the first electrode in a first buffer solution tank into which a first opening of a sample separating section opens; fixing the second electrode oppositely to a second opening of the sample separating section; disposing the second opening of the sample separating section and the second electrode in a second buffer solution tank; and holding the adsorption member between the second opening of the sample separating section and the second electrode.

It is preferable that the sample separation/adsorption method of the present invention further includes the step of changing the relative position of the second electrode (or the adsorption member) and the second opening along the second direction substantially vertical to the first opening defined by the first opening and the second opening.

The sample separation/adsorption appliance of the present invention includes: the first buffer solution tank to be filled with the first buffer solution, the first buffer solution tank being provided in an upper portion of the separation medium where electrophoresis is carried out; the second buffer solution tank to be filled with the second buffer solution, the second buffer solution tank being provided in a lower portion of the separation medium; the first electrode in the first buffer solution tank; the second electrode for passing electricity in the second buffer solution tank; and the adsorption member between an end surface of the separation medium which is located in the second buffer solution tank and the second electrode, sample components having been moved through the separation medium by electricity and then discharged from the end surface of the separation medium which is located in the second buffer solution tank being adsorbed onto the adsorption member while the adsorption member is moved relatively to the separation medium.

In the sample separation/adsorption appliance of the present invention, it is preferable that the second buffer solution tank to be filled with the second buffer solution is disposed horizontally, the second electrode is disposed on the bottom of the second buffer solution tank, the adsorption member is disposed on the second electrode, the separation medium is disposed substantially vertically to the adsorption member, the second buffer solution tank is filled with the second buffer solution, the first buffer solution tank for storing the first buffer solution is disposed on an upper end of the separation medium, the sample is applied on an end surface of the separation medium which is located in the first buffer solution tank, the first electrode for applying a voltage is disposed in the first buffer solution tank, the sample is separated and is moved downward by the electrophoresis, and separation and adsorption are performed by relatively moving the separation medium and the adsorption member.

In the sample separation/adsorption appliance of the present invention, it is preferable that the separation medium is disposed substantially horizontally, and the adsorption member is moved substantially vertically.

In the sample separation/adsorption appliance of the present invention, it is preferable that a part of the second electrode which is in contact with the adsorption member has a wire shape and has substantially the same width as or smaller width than the thickness of the end surface of the separation medium which is located in the second buffer solution tank, and the second electrode does not move with respect to the end surface of the separation medium which is located in the second buffer solution tank when the adsorption member is moved.

In the sample separation/adsorption appliance of the present invention, it is preferable that the second electrode which is in contact with the adsorption member can have a plane shape, and in this case, the separation medium moves relatively with respect to the adsorption member in a state where the second electrode does not move with respect to the adsorption member, and the second electrode has the same size as or larger size than the scope where the separation medium can move when separation sample is transferred from the separation medium to the adsorption member.

In the sample separation/adsorption appliance of the present invention, it is preferable that the second electrode can be divided into stripe electrodes, and in this case, the sample separation/adsorption appliance has an arrangement in which a voltage is always applied to the stripe second electrode closest to the end surface of the separation medium in accordance with the movement of the adsorption member.

In the sample separation/adsorption appliance of the present invention, it is preferable that the adsorption member has the shape of a membrane, and in this case, movement means for relatively moving the separation medium and the adsorption member is arranged so as to be unrolled from a rolled-up state and/or to be rolled up into a roll after separation and transfer.

In the sample separation/adsorption appliance of the present invention, it is preferable that the applied voltage and the relative velocity between the separation medium and the adsorption member are controlled temporally.

In the sample separation/adsorption appliance of the present invention, the control may be carried out depending on a current value between the first electrode and the second electrode.

In the sample separation/adsorption appliance of the present invention, another arrangement is possible in which a fluorescence-labeled marker component is disposed with a sample on an end surface of the separation medium which is located in the first buffer solution tank, a fluorescence detection section detects fluorescent spots, and the control is carried out depending on the velocity of the fluorescent spots.

In the sample separation/adsorption appliance of the present invention, the separation medium may be thinner at the side where electrophoresis ends than at the side where electrophoresis starts.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1 is a schematic view showing a substantial part of an embodiment of a sample separation/adsorption appliance of the present invention.

FIG. 2 is a schematic view showing the substantial part of an embodiment of a sample separation/adsorption appliance of the present invention.

FIG. 3 is a schematic view showing the substantial part of an embodiment of a sample separation/adsorption appliance of the present invention.

FIG. 4 (a) is a conceptual view showing an outline of sample separation and adsorption in a sample separation/adsorption appliance of the present invention.

FIG. 4 (b) is a conceptual view showing an outline of sample separation and adsorption in a sample separation/adsorption appliance of the present invention.

FIG. 4 (c) is a conceptual view showing an outline of sample separation and adsorption in a sample separation/adsorption appliance of the present invention.

FIG. 5 is a schematic view showing the substantial part of an embodiment of a sample separation/adsorption appliance of the present invention.

FIG. 6 is a schematic view showing the substantial part of an embodiment of a sample separation/adsorption appliance of the present invention.

FIG. 7 is a schematic view showing the substantial part of an embodiment of a sample separation/adsorption appliance of the present invention.

FIG. 8 is a schematic view showing the substantial part of an embodiment of a sample separation/adsorption appliance of the present invention.

FIG. 9 is a schematic view showing a movement of a sample in accordance with time progress in a sample separation/adsorption appliance of the present invention.

FIG. 10 is a schematic view showing a movement of a sample in accordance with time progress in a sample separation/adsorption appliance of the present invention.

FIG. 11 is a schematic view showing a movement of a sample in accordance with time progress in a sample separation/adsorption appliance of the present invention.

FIG. 12 is a schematic view showing a movement of a sample in accordance with time progress in a sample separation/adsorption appliance of the present invention.

FIG. 13 is a cross-sectional view showing a substantial part of an electrophoresis and adsorption appliance in accordance with an embodiment of the present invention.

FIG. 14 is a cross-sectional view showing the substantial part of an electrophoresis and adsorption appliance in accordance with an embodiment of the present invention.

FIG. 15 is a view explaining resolution in an embodiment of a sample separation/adsorption appliance of the present invention.

FIG. 16 is a view explaining resolution in an embodiment of a sample separation/adsorption appliance of the present invention.

FIG. 17 is a view explaining resolution in an embodiment of a sample separation/adsorption appliance of the present invention.

### REFERENCE NUMERALS

1: first buffer solution tank
2: second buffer solution tank
3: sample separating section
4: second electrode fixing means
5: adsorption member holding means
6: adsorption member
7: driving means
9: board
10: sample (sample medium)
10a, 10b: sample component
11: first buffer solution
12: first electrode
21: second buffer solution
22: second electrode
22a: plane second electrode
22b: striped second electrode
22c: line-shaped second electrode
31: first opening
32: second opening
33: separation medium
34, 34a, 34b: board insulator
41: insulating substrate
71: first driving means
71b: arm
72: second driving means
72a: roll (section for unrolling adsorption member)
72b: roll (section for rolling up adsorption member)
72c: guide
81: calculating section (data processing section)
82: roll control section
83: driving means control section
91: light irradiation section
92: fluorescence detection section
100: sample separation/adsorption appliance
111: power supply
112: wiring
113: switch
114: ammeter
M: first direction
N: second direction
P: modulation of electrophoresis
Q: modulation of moving velocity of adsorption member

### BEST MODE FOR CARRYING OUT THE INVENTION

### First Embodiment

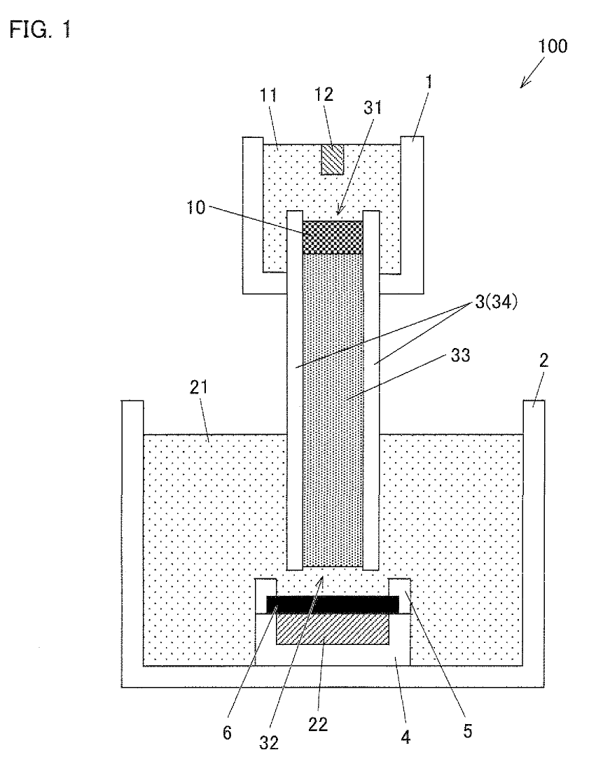

One embodiment of a sample separation/adsorption appliance 100 of the present invention is described below with reference to FIGS. 1 through 7.

FIG. 1 is a cross-sectional view of a sample separation/adsorption appliance 100 of the present embodiment in a state of carrying out separation/adsorption of the sample.

The sample separation/adsorption appliance 100 includes a first buffer solution tank 1, a second buffer solution tank 2 and a sample separating section 3. The sample separating section 3 can contain a separation medium 33 for separating a sample 10. FIG. 1 shows a state where the sample separating section 3 contains the separation medium 33. The sample separating section 3 is composed of two board insulators 34 and spacers (not shown) for creating, between the board insulators 34, a space where the separation medium 33 is to be contained.

The sample separating section 3 has a first opening 31 and a second opening 32 in an upper portion and a lower portion of FIG. 1, respectively. The first opening 31 and the second opening 32 open into the first buffer solution tank 1 and the second buffer solution tank 2, respectively. When separation of the sample 10 is carried out, a first electrode 12 and a second electrode 22 are disposed in the first buffer solution tank 1 and the second buffer solution tank 2 respectively, the first buffer solution tank 1 and the second buffer solution tank 2 are filled with a first buffer solution 11 and a second buffer solution 21 respectively, and the sample 10 is applied to an upper portion of the separation medium 33 via the first opening 31. Next, by applying a voltage across the first electrode 12 and the second electrode 22, individual components included in the sample 10 move toward a lower portion of FIG. 1. The sample 10 is separated in the separation medium 33 in accordance with the differences in mobility of the individual sample components.

As shown in FIG. 1, the sample separation/adsorption appliance 100 of the present embodiment further includes second electrode fixing means 4 for disposing the second electrode 22 oppositely to the second opening 32. FIG. 1 shows a state where the second electrode fixing means 4 provided in the second buffer solution tank 2 fixes the second electrode 22. With this arrangement, the sample components which moved toward the lower portion of FIG. 1 by applying a voltage across the first electrode 12 and the second electrode 22 are discharged from the second opening 32 of the sample separating section 3 toward the second electrode 22 fixed on the second electrode fixing means 4.

The sample separation/adsorption appliance 100 of the present embodiment further includes adsorption member holding means 5 for holding, between the second opening 32 and the second electrode 22, an adsorption member 6 for adsorbing the sample components discharged from the second opening 32. FIG. 1 shows a state where the adsorption member holding means 5 which is joined to the second electrode fixing means 4 provided in the second buffer solution tank 2 presses the adsorption member 6 onto the second electrode 22 and holds the adsorption member 6. With this arrangement, the sample components discharged from the second opening 32 toward the second electrode are adsorbed onto the adsorption member 6 held by the adsorption member holding means 5.

The term “sample” is synonymous with a specimen and preparation in the art. In the present specification, the “sample” means a “biological sample” or its equivalent. The “biological sample” means any preparation obtained from biological materials (e.g. body, body fluid, cell line, cultured tissue or tissue section) as a resource. Examples of the biological sample include body fluid (e.g. blood, saliva, dental plaque, serum, blood plasma, urine, synovial fluid and spinal fluid) and a tissue resource. A subject sample is preferable for the biological sample. The preferable subject sample includes skin lesion, sputum, pharyngeal mucus, nasal mucus, pus and secretion which are obtained from a subject. In the present specification, the term “tissue sample” means the biological sample obtained from the tissue resource. A method for obtaining a biopsied tissue and a body fluid is well known in the art.

In the present specification, the term “sample” includes a protein sample, a genome DNA sample and/or a total RNA sample extracted from the biological sample and the tissue sample in addition to the biological sample and the tissue sample. Further, the “sample components” mean various kinds of factors (components) constituting the “sample”.

It should be noted that the second electrode can be used as an adsorption member, and the separated sample can be adsorbed directly on the second electrode. In this case, in the sample separation/adsorption appliance 100, the second electrode 22 can serve as the adsorption member 6, and the second electrode fixing means 4 can serve as the adsorption member holding means 5.

Further, in the sample separation/adsorption appliance 100 of the present embodiment, it is possible to perform molecular weight separation using aclylamide gel as the separation medium 33 (i.e. SDS-PAGE). The sample 10 may be, for example, one-dimensional gel including a sample separated by isoelectric focusing electrophoresis.

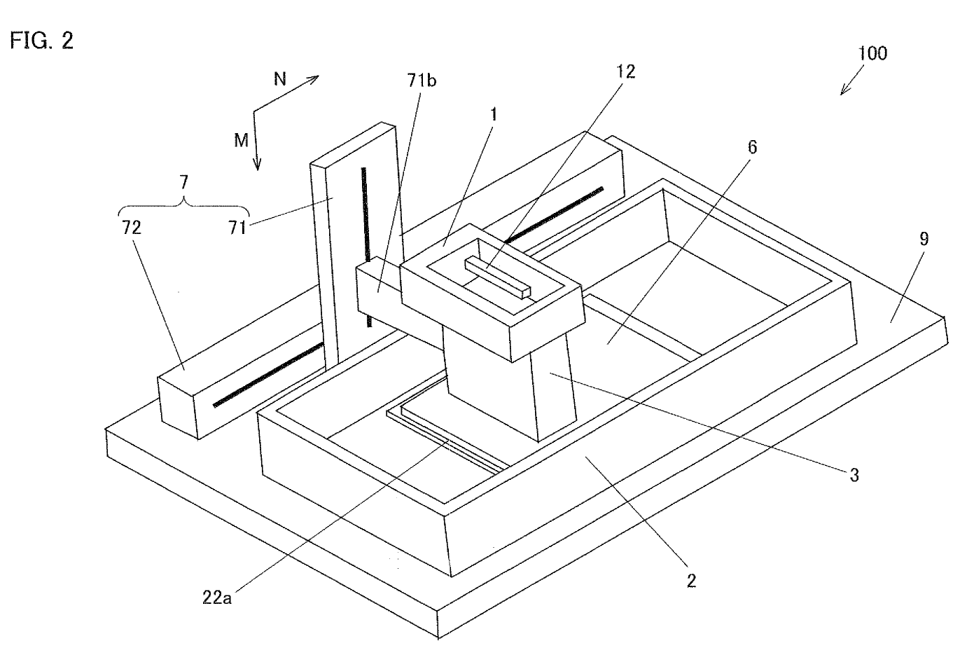

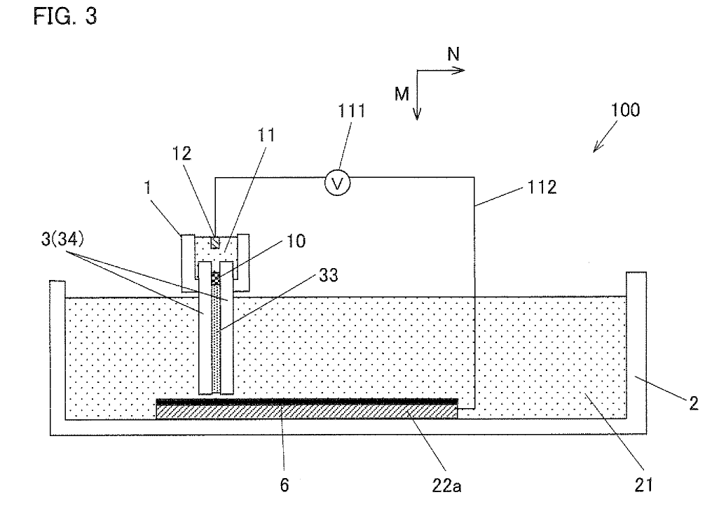

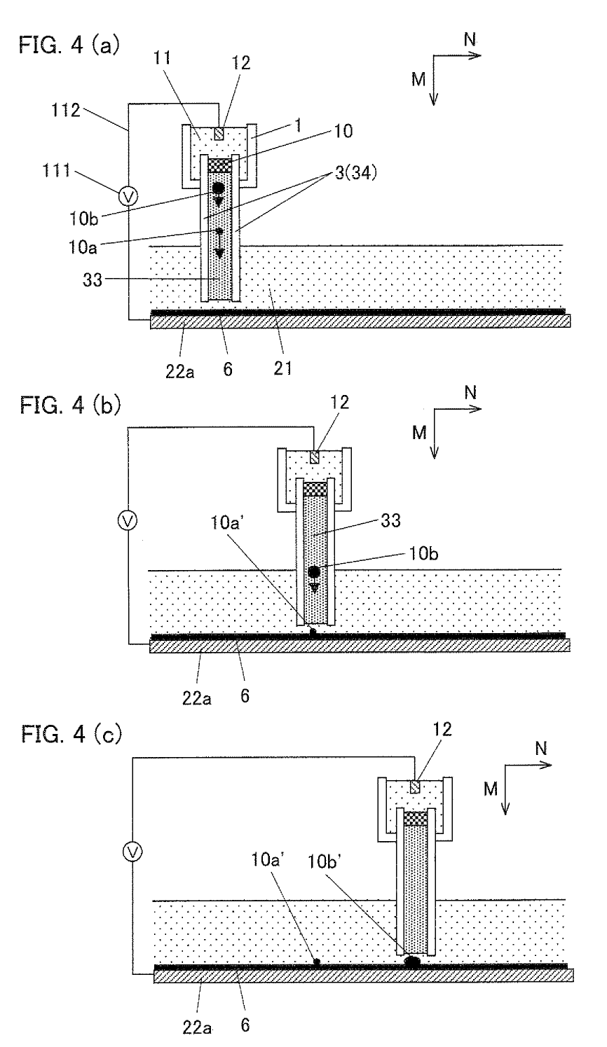

The following explains, with reference to a perspective view (FIG. 2), a cross-sectional view (FIG. 3) and a conceptual view (FIG. 4), an arrangement of the sample separation/adsorption appliance 100, which is necessary in the case where a plurality of sample components are adsorbed onto the adsorption member 6 while keeping the separation pattern. It should be noted that in FIGS. 2 through 4, the second electrode fixing means 4 and the adsorption member holding means 5 are omitted for the purpose of simplifying the drawings.

FIG. 2 is a perspective view of the sample separation/adsorption appliance 100. In FIG. 2, the second buffer solution tank 2 is fixed on a board 9 for fixing the whole of the sample separation/adsorption appliance 100, a plane second electrode 22a is fixed on the bottom of the second buffer solution tank 2, and the adsorption member 6 is held on the second electrode 22a. The first buffer solution tank 1 is disposed on a top surface of the sample separating section 3 disposed substantially vertically to the board 9 in such a manner as to be joined to the sample separating section 3. The sample separating section 3 is further joined to first driving means 71 via an arm 71b, and the first driving means 71 is further joined to second driving means 72 fixed on the board 9. The first driving means 71 and the second driving means 72 allow controlling a movement of the sample separating section 3 in a direction substantially vertical to the board 9 (first direction M) and a direction substantially horizontal to the board 9 (second direction N).

FIG. 3 is a cross-sectional view showing a state where the first driving means 71 and the second driving means 72 are omitted from the sample separation/adsorption appliance 100 shown in FIG. 2. FIG. 3 shows a state where a voltage is applied across the first electrode 12 and the second electrode 22a via a wiring 112 by a power supply 111. As shown in FIG. 3, the first buffer solution tank 1 is filled with the first buffer solution 11, the second buffer solution tank 2 is filled with the second buffer solution 21, and the first electrode 12 is immersed in the first buffer solution 11. Further, the sample 10 is applied on the separation medium 33 in a state where a bottom surface of the separation medium 33 is in contact with the second buffer solution 21, and a top surface of the separation medium 33 is in contact with the first buffer solution 11.

FIG. 4 is a conceptual view showing the separation/adsorption of the sample components in the sample separation/adsorption appliance 100. The sample 10 is applied on the top of the separation medium 33. When a voltage is applied across the first electrode 12 and the second electrode 22a by the power supply 111, the sample 10 moves through the separation medium 33 along the first direction M and is separated into sample components 10a and 10b in accordance with the differences in mobility (see FIG. 4 (a)). When the voltage is continued to be applied, the sample components 10a and 10b are discharged from the bottom end of the separation medium 33, and the discharged sample components 10a and 10b are electrically attracted to the plane second electrode 22a and are adsorbed onto the adsorption member 6. As a result, adsorption spots 10a′ and 10b′ are formed on the adsorption member 6 (see FIGS. 4 (b) and (c)). When the sample separating section 3 is moved along the second direction N while carrying out the sample separation (electrophoresis), the adsorption spots 10a′ and 10b′ are formed on different positions in accordance with the difference in time when the sample components 10a and 10b are discharged. With this operations, the separation patterns of the separated sample components 10a and 10b are reflected on the adsorption member 6 as adsorption patterns 10a′ and 10b′, and the adsorption patterns of a plurality of sample components can be obtained.

As described above, in order to reflect on the adsorption member the separation pattern of the sample as an adsorption pattern, it is necessary to relatively move the sample separating section 3 and the adsorption member 6. It should be noted that the sample separating section 3 may move while the adsorption member 6 may stand still, or the adsorption member 6 may move while the sample separating section 3 may stand still.

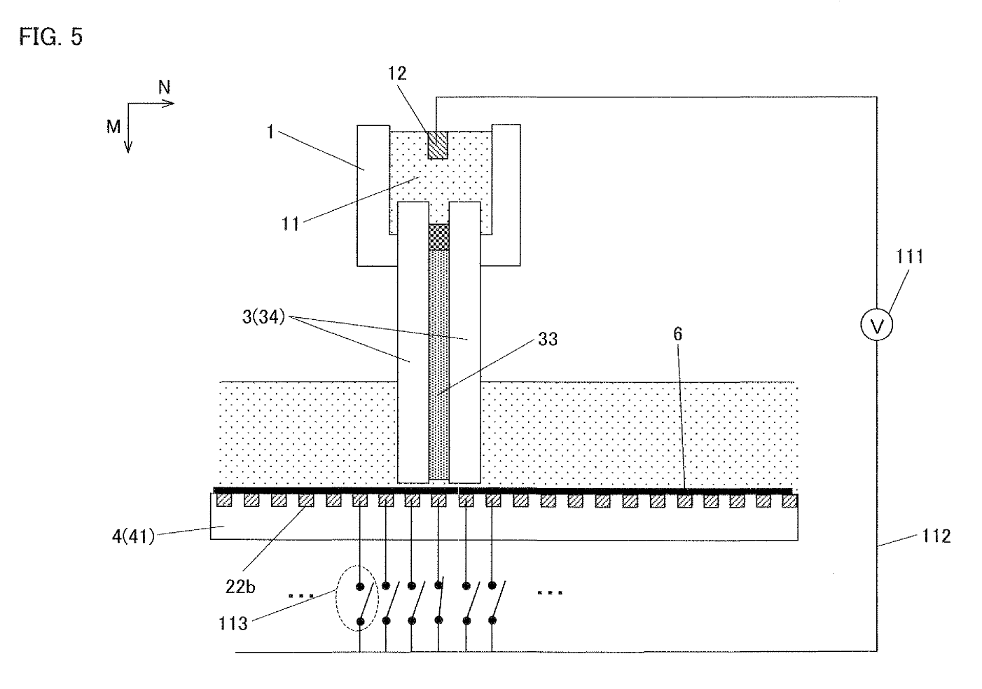

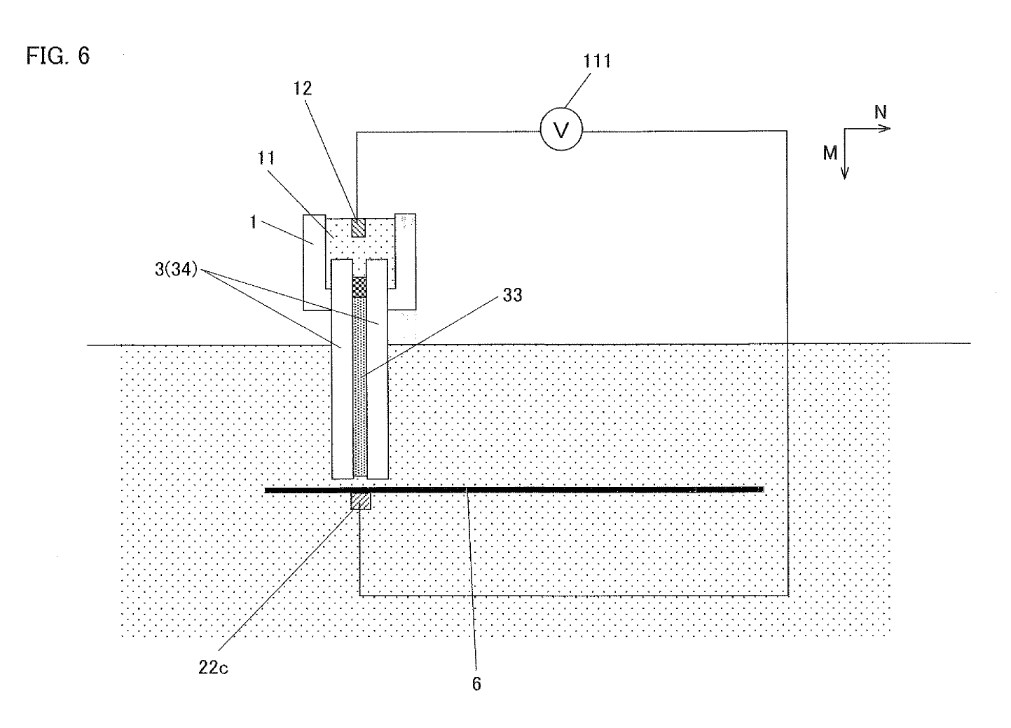

As the second electrode, the plane electrode 22a shown in FIGS. 2 through 4 can be used. However, in this case, lines of electric force which extend from the end surface of the separation medium 33 to the second electrode may widen. This can cause decline in resolution because the sample components discharged from the separation medium 33 diffuse. In order to prevent deterioration of the resolution, it is preferable that the area of the second electrode is made smaller. The following explains variations of the second electrode with reference to FIGS. 5 and 6. It should be noted that also in FIGS. 5 and 6, the second electrode fixing means 4 and the adsorption member holding means 5 are omitted for the purpose of simplifying the drawings.

FIG. 5 is a cross-sectional view of the sample separation/adsorption appliance 100 in which a plurality of striped second electrodes 22b are disposed on an insulating substrate 41 which doubles as the second electrode fixing means 4. By using the striped second electrodes 22b, the total area of the electrodes can be made smaller than that of the plane second electrode. Like the case in which the plane electrode is used, the second electrodes 22b do not move with respect to the adsorption member 6 when the relative position between the sample separating section 3 and the second electrode 22b is changed. Further, it is more preferable that a switch 113 is used in electrically switching application of a voltage in order to switch on only the second electrode closest to the bottom end surface of the separation medium 33. It should be noted that the switch 113 may be mechanical or may be realized by an electric circuit.

Alternatively, as shown in FIG. 6, it is preferable that a line-shaped second electrode 22c is used in order to concentrate the lines of electric force which extend from the bottom end surface of the separation medium 33 to the second electrode. It should be noted that in this case, the second electrode 22c needs to stand still with respect to the sample separating section 3. It should be noted that the line-shaped second electrode 22c may be joined to the sample separating section 3 or may be provided in the second buffer solution tank 2.

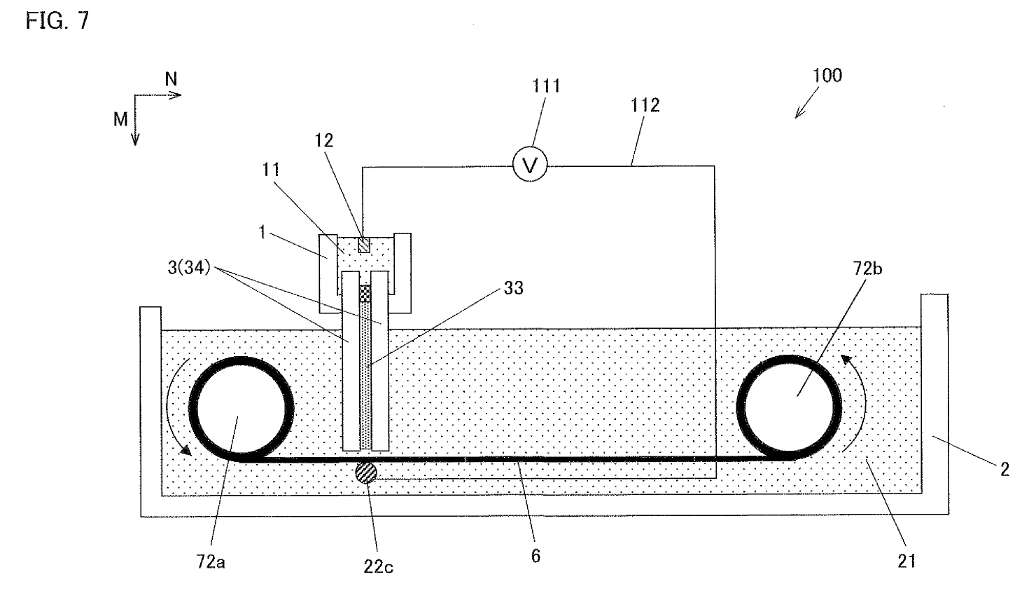

The first driving means 71 and the second driving means 72 are not limited to those shown in FIG. 2, provided that the first driving means 71 and the second driving means 72 can successfully carry out movements in the first direction and the second direction, respectively. The following explains an example of the second driving means with reference to FIG. 7. It should be noted that also in FIG. 7, the second electrode fixing means 4 is omitted for the purpose of simplifying the drawing.

FIG. 7 is a cross-sectional view of the sample separation/adsorption appliance 100 having an arrangement in which the sample separating section 3 is disposed vertically, and the adsorption member 6 is carried by using a roll 72a which is a section for unrolling the adsorption member and a roll 72b which is a section for rolling up the adsorption member. The roll 72a and the roll 72b are fixed on a second electrode layer 2 and also serve as the adsorption member holding means for disposing the adsorption member in a predetermined position. As shown in FIG. 7, the second electrode 22c is provided oppositely to the second opening of the sample separating section 3. It should be noted that the second electrode fixing means (not shown) for fixing the second electrode 22c may be fixed with the second buffer solution tank 2 or may be fixed with the sample separating section 3. The rolls 72a and 72b rotate in a direction designated by the arrow shown in FIG. 7, so that a plurality of sample components discharged from the separation medium 33 are adsorbed onto the adsorption member 6, and the adsorption patterns are formed on the adsorption member 6.

### Second Embodiment

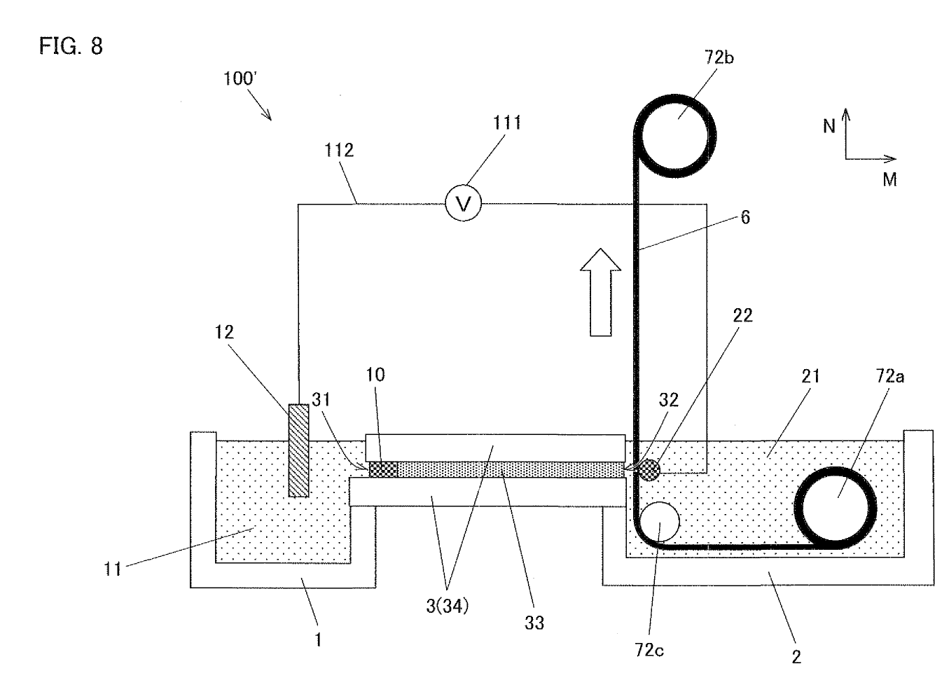

Explained in the First Embodiment is an exemplary case in which the relative position between the second opening and the second electrode (or the adsorption member) is changed substantially horizontally to the board for fixing the whole of the sample separation/adsorption appliance 100 (or a surface of the second buffer solution 21). Alternatively, the present invention may be arranged so that the sample separation step is carried out in a substantially horizontal direction, and the adsorption step is carried out in a substantially vertical direction. The following explains, with reference to FIG. 8, the Second Embodiment of the present invention in which the relative position between the second opening and the second electrode (or the adsorption member) is changed substantially vertically to the board for fixing the whole of the sample separation/adsorption appliance 100 (or a surface of the second buffer solution 21).

FIG. 8 is a cross-sectional view of a sample separation/adsorption appliance 100′ in a state of carrying out the sample separation and adsorption.

The sample separation/adsorption appliance 100′ includes a first buffer solution tank 1, a second buffer solution tank 2 and a sample separating section 3. The sample separating section 3 can contain a separation medium 33 for separating a sample 10. FIG. 8 shows a state where the sample separating section 3 contains the separation medium 33. The sample separating section 3 is consisted of two board insulators 34 and spacers (not shown) for creating, between the board insulators 34, a space where the separation medium 33 is to be contained.

The sample separating section 3 has a first opening 31 and a second opening 32 in a left portion and a right portion of FIG. 8, respectively. The first opening 31 and the second opening 32 open into the first buffer solution tank 1 and the second buffer solution tank 2, respectively. When the separation of the sample 10 is carried out, a first electrode 12 and a second electrode 22 are disposed in the first buffer solution tank 1 and the second buffer solution tank 2 respectively, the first buffer solution tank 1 and the second buffer solution tank 2 are filled with the first buffer solution 11 and the second buffer solution 21 respectively, and the sample 10 is applied to the separation medium 33 via the first opening 31. Next, by applying a voltage across the first electrode 12 and the second electrode 22, individual components included in the sample 10 move toward the right portion of FIG. 8. The sample 10 is separated in the separation medium 33 in accordance with the differences in mobility of individual sample components. The second electrode fixing means for fixing the second electrode 22 is not shown in FIG. 8. With this arrangement, the sample components which moved toward the right portion of FIG. 8 by applying a voltage across the first electrode 12 and the second electrode 22 are discharged from the second opening 32 of the sample separating section 3 toward the second electrode 22 fixed on the second electrode fixing means 4. It should be noted that the second electrode fixing means may be fixed on the second buffer solution tank 2 or may be fixed on the sample separating section 3.

The sample separation/adsorption appliance 100′ of the present embodiment includes, as second driving means, a roll 72a which is a section for unrolling an adsorption member 6 and a roll 72b which is a section for rolling up the adsorption member 6 (see FIG. 8). The roll 72a is fixed on the second electrode layer 2, and the roll 72b is fixed on the sample separation/adsorption appliance 100′ via a holding section (not shown). It should be noted that the rolls 72a and 72b also serve as adsorption member holding means for holding, between the second opening 32 and the second electrode 22, the adsorption member 6 for adsorbing the sample components discharged from the second opening 32. FIG. 8 shows a state where the adsorption member holding means 5 joined to the second electrode fixing means 4 disposed in the second buffer solution tank 2 presses the adsorption member 6 onto the second electrode 22 and holds the adsorption member 6. With this arrangement, the sample components discharged from the second opening 32 toward the second electrode are absorbed onto the adsorption member 6 held by the adsorption member holding means 5.

With the above arrangement, in the sample separation/adsorption appliance 100′, the relative position between the second opening and the second electrode (or the adsorption member) can be changed substantially vertically to the surface of the second buffer solution 21. It is also preferable that a guide 72c shown in FIG. 8 is used in order to successfully change the relative position.

FIG. 8 does not show first driving means for controlling the movement along the first direction (direction designated by M in FIG. 8) defined by the first opening 31 and the second opening 32. It should be noted that the first driving means can serve as sample driving means for disposing the sample 10 so that the sample 10 is successfully in contact with the separation medium 33. Therefore, as in the First Embodiment, the sample 10 is, for example, a one-dimensional gel which contains a sample separated by isoelectric focusing electrophoresis.

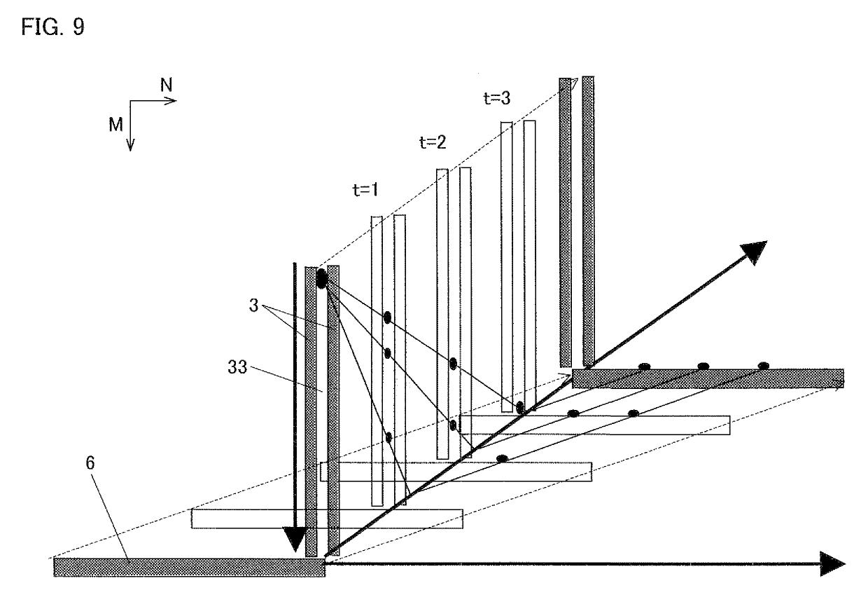

FIG. 9 shows a relationship between the sample movement and the adsorption pattern in carrying out the present invention. The sample separating section 3 and the adsorption member 6 are shown in one-dimension in FIG. 9. The movement of the separation spots with respect to time progress is shown in a time axis direction. Explained in FIG. 9 is an exemplary case in which the adsorption member 6 moves.

By applying a voltage, the sample components move through the separation medium 33 in the first direction M. The sample components are separated in accordance with the difference in mobility, are discharged from the bottom surface of the separation medium, and are adsorbed onto the adsorption member 6. The adsorption member 6 moves in the second direction N in accordance with the time progress (t=1, t=2, t=3). Therefore, the difference in time between starting of the separation of the sample components and the discharging of the sample components is reflected on the adsorption member 6 as a pattern.

In the present invention, a voltage is applied until the sample component whose mobility is smallest is discharged from the bottom surface of the separation medium and is transferred onto the adsorption member. However, in a case of transfer after electrophoresis in a conventional art, the electrophoresis is stopped before the sample component whose mobility is largest reaches the bottom surface of the separation medium, and then the adsorption pattern (separation pattern) is detected. In the conventional electrophoresis, the separation pattern is formed in accordance with the differences in moving distances of the sample components. In contrast thereto, in the present invention, the pattern is formed in accordance with the differences in time necessary for the sample components to travel a predetermined distance. In other words, in the conventional electrophoresis, the pattern is formed in proportion to the mobility, whereas in the present invention, the pattern is formed in proportion to the inverse of the mobility.

Generally, when a sample such as a protein is separated by SDS-PAGE, the spot distance in the area of low molecular weight is large, and the spot distance in the area of high molecular weight is short. Therefore, the resolution is insufficient in the area of high molecular weight. In order to solve such a problem, a gradient gel having a density gradient is used. In the present invention, this problem can be solved because the pattern is formed in proportion to the inverse of the mobility.

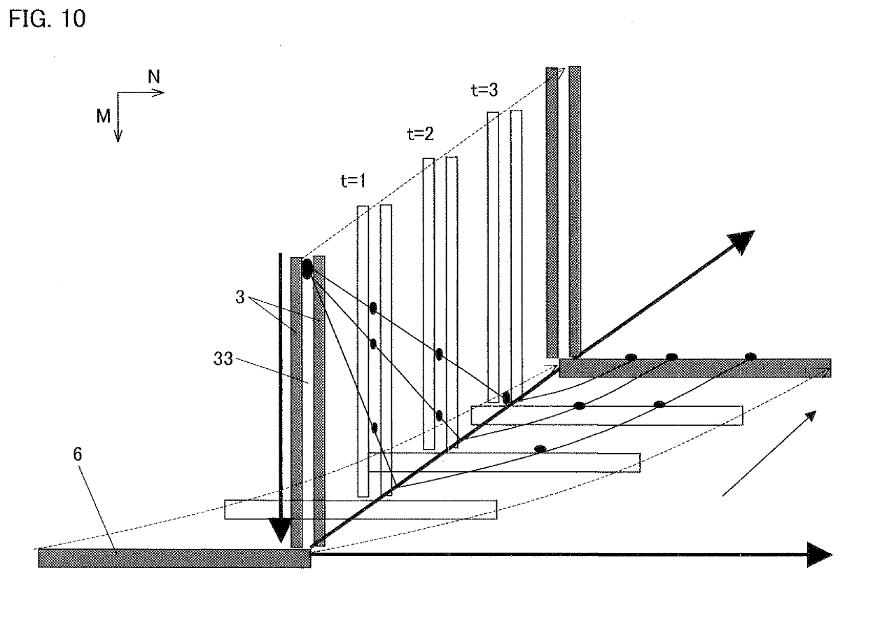

However, the case in which a pattern similar to a conventional pattern is required for the purpose of comparing the pattern of the present invention with the conventional electrophoresis pattern must be taken into consideration. In the present invention, it is possible to control moving velocity of the adsorption member independently of the progress of the sample separation (electrophoresis). Therefore, it is possible to form a pattern similar to a conventional pattern by adjusting the moving velocity or the applied voltage. FIG. 10 shows a method for obtaining a pattern similar to the conventional electrophoresis pattern by reducing the moving velocity of the adsorption member 6 in accordance with the progress of the electrophoresis. In this case, it is possible to increase the voltage applied to the sample separating section 3 as time elapses while maintaining the moving velocity of the adsorption member 6.

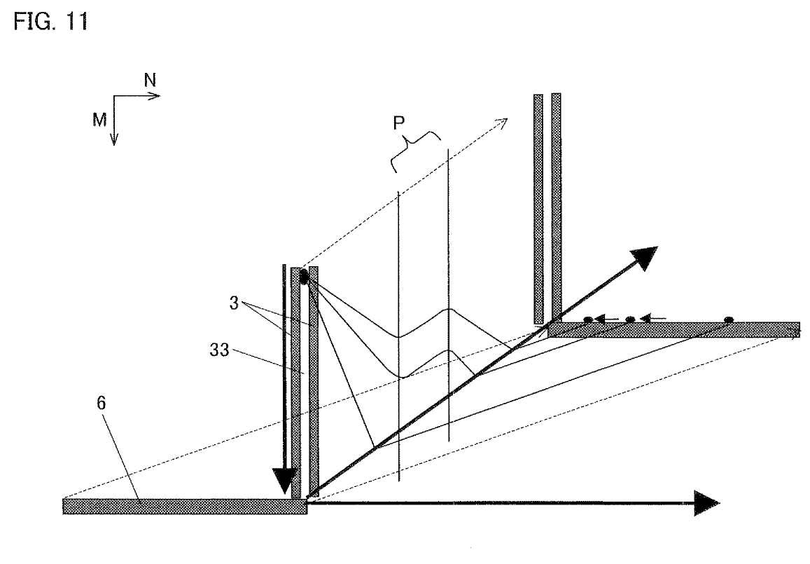

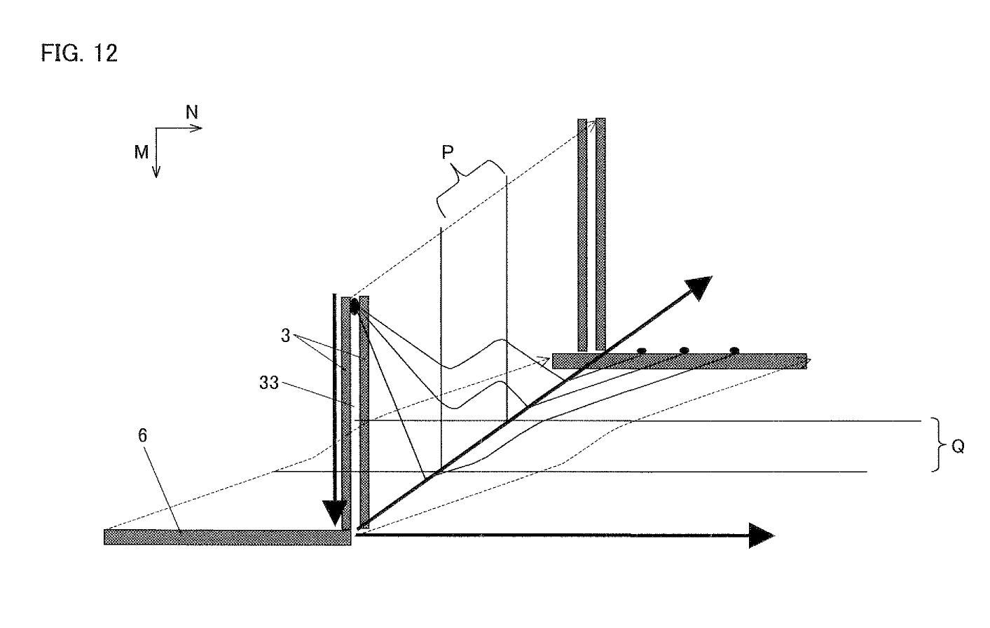

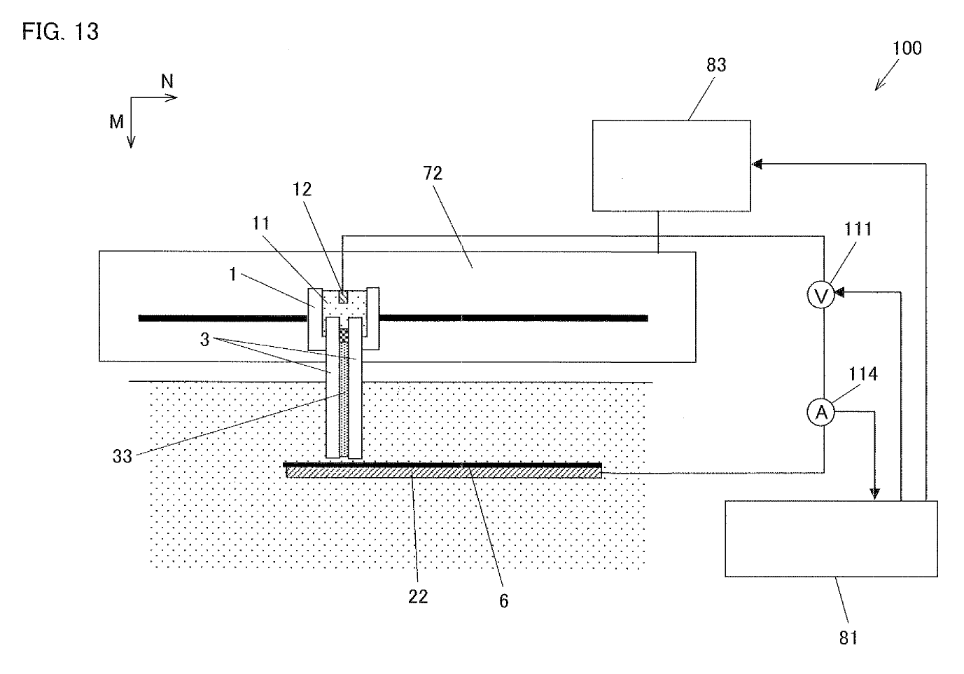

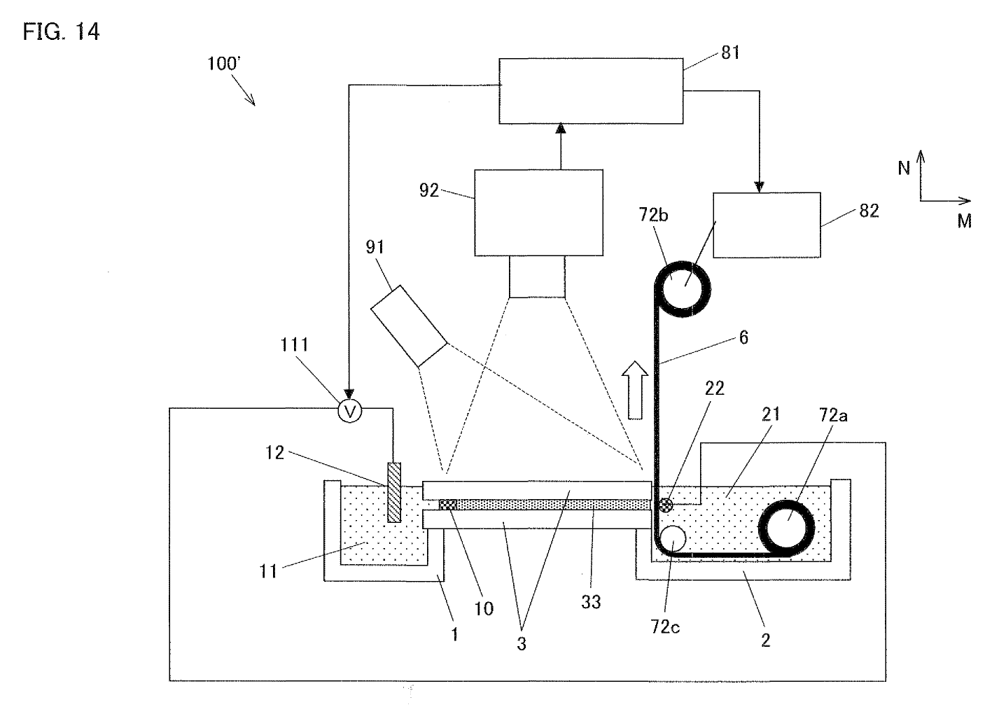

In the case in which the adsorption member 6 is driven to move independently of the progress of the electrophoresis, modulation of the moving velocity of the sample spot in the separation medium 33 which change is caused by voltage drop or the like causes the difference in adsorption pattern (modulation P shown in FIG. 11). In the conventional electrophoresis, even if the voltage or the like is changed during the electrophoresis, the whole of the electrophoresis medium is modulated and therefore the eventual pattern is hardly influenced. In the present invention, in order to avoid such a problem, it is possible to control the applied voltage or the moving velocity of the adsorption member by monitoring the velocity of the electrophoresis (modulation Q shown in FIG. 12). Specifically, in the sample separation/adsorption appliance 100 having the arrangement shown in FIG. 13, an ammeter 114 monitors a current in electrophoresis, and a data processing section 81 calculates a change in moving velocity from a change in current value in order to control a voltage applied across the first electrode 12 and the second electrode 22 or control a driving means control section 83 for controlling the driving of the second driving means 72. Alternatively, a fluorescence-labeled marker sample is electrophoresed along with a sample to be separated, a fluorescence detection section 92 detects the moving velocity of the marker sample, the data processing section 81 calculates a modulation in the moving velocity to control a voltage applied across the first electrode 12 and the second electrode 22 or a roll control section 82 controls the roll 72b (section for rolling up the adsorption member) of the adsorption member 6 (see FIG. 14).

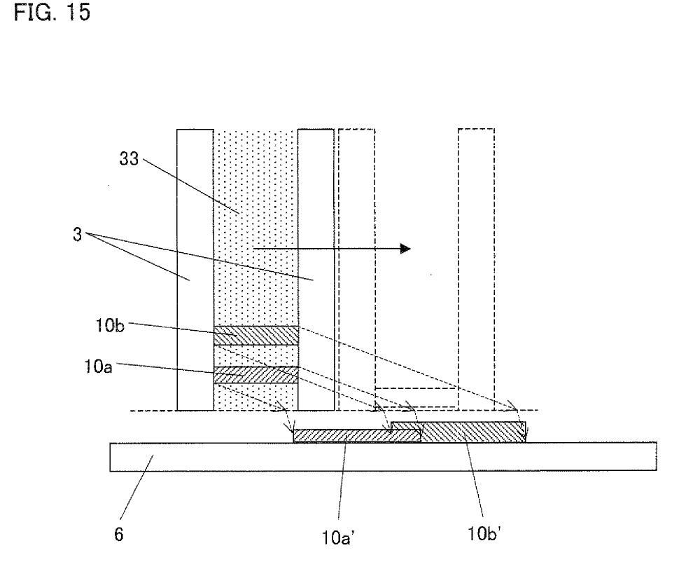

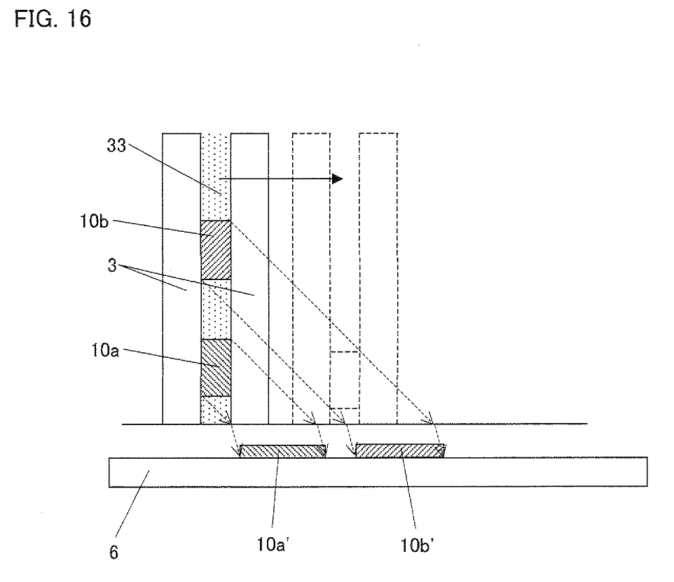

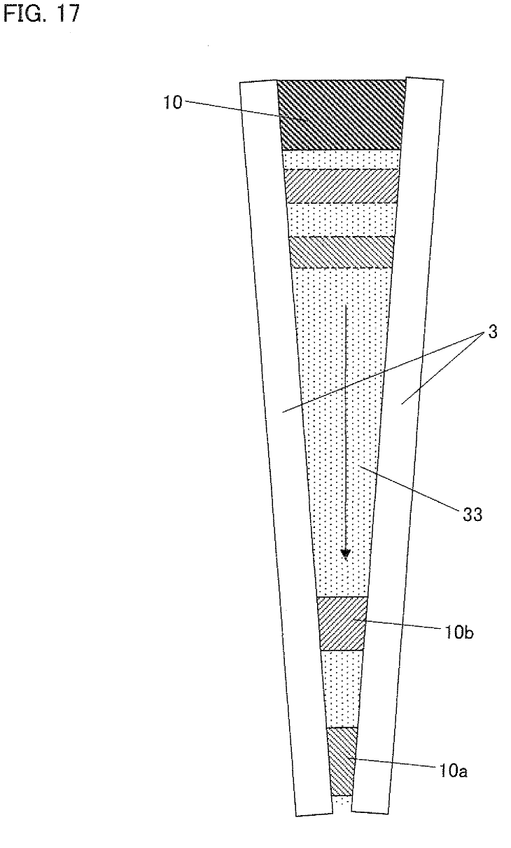

As shown in FIG. 15, the thickness of the separation medium 33 causes deterioration in resolution of transferred adsorption spots 10a′ and 10b′. In the worst case, the adsorption spots 10a′ and 10b′ overlap. As shown in FIG. 16, by sufficiently thinning the thickness of the separation medium 33, it is possible to avoid the deterioration in the resolution of the adsorption spots 10a′ and 10b′. However, in the case where the separation medium 33 is thin, it is difficult to put a sample into the separation medium 33. Therefore, as shown in FIG. 17, this problem can be solved by thickening the entrance (i.e. first opening) of the separation medium 33 and by thinning the exit (i.e. second opening) of the separation medium 33.

It is preferable that the separation medium 33 is in contact with the first buffer solution 11 and the second buffer solution 21 only at the first opening 31 and the second opening 32, respectively. Therefore, the sample separating section 3 in which the separation medium 33 is to be contained preferably made of an insulator and is further preferably made of a high-waterproof material. Further, for the purpose of detecting the sample components (e.g. 10a and 10b) without detaching the separation medium 33 from the sample separating section 3 in such a case as real time monitoring, it is preferable that the sample separating section 3 is made of a material with high light-transmittance. Examples of the material having such a characteristic include glass and resin. Examples of resin material include PMMA, PDMS, COP, polycarbonate, polystyrene, PET and polyvinyl chloride. Acrylic resin (e.g. polymethyl methacrylate (PMMA)) is preferable in view of weight, handleability, and productivity.

The first buffer solution tank 1, the second buffer solution tank 2 and the sample separating section 3 may be made of the same material or may be made of different materials. It is preferable that the first buffer solution tank 1 and the second buffer solution tank 2 are made of a high-waterproof material because they are filled with the buffer solution.

The first electrode 12 and the second electrode 22 respectively provided in the first buffer solution tank 1 and the second buffer solution tank 2 may be fixed or may not be fixed. When fixed, the first electrode 12 and the second electrode 22 may be conductors formed by patterning in the first buffer solution tank 1 and the second buffer solution tank 2, respectively.

In the Embodiment 1, the Embodiment 2 and the drawings, the adsorption member 6 is in contact with the second electrode 22 for the easy understanding of the position of the second opening 32. It should be noted that the adsorption member 6 does not need to be in contact with the second electrode 22 when carrying out the present invention. That is, the adsorption member 6 may be in contact with the second opening 32 or may be in contact with the second electrode 22 or may not be in contact with both of them. Further, even if the second opening 32, the adsorption member 6 and the second electrode 22 are in contact with each other, the present invention can be successfully carried out. One skilled in the art who read the present specification easily understands that the adsorption member holding means 5 only needs to serve to hold the adsorption member 6 between the second opening 32 and the second electrode 22. Further, One skilled in the art who read the present specification easily understands that if necessary, the first driving means 71 serves to adjust the distance between the second opening 32, the adsorption member 6 and the second electrode 22.

Further, all the academic documents and the patent documents cited in the present specification are incorporated by reference herein.

### EXAMPLE

### Example 1

### First-Dimension Electrophoresis

### Sample Medium 10

Immobiline immobilized pH gradient isoelectric focusing gel which was cut into a piece of 1 mm×60 mm was used. The sample introduction and the gel swelling were performed, and the electrophoresis was carried out at 3500V for eight hours.

(Sample Separating Section 3)

A tapered spacer was sandwiched by two board insulators 34 of 60 mm×50 mm in length and breadth and 2 mm in thickness. The sample separating section 3 was filled with polyacrylamide gel as the separation medium 33. The thickness of the gel was 0.2 mm at the exit and 1.0 mm at the entrance. The board insulators 34 holding the separation medium were made of glass or resin (e.g. PMMA (polymethyl methacrylate)).

(First Buffer Solution Tank 1)

The first buffer solution tank 1 of 70 mm×10 mm in length and breadth and 10 mm in depth was disposed at a top end of the sample separating section 3. The sample medium 10 having been subjected to first-dimension electrophoresis was equilibrated and was fixed on the top surface of the separation medium 33 by agarose. The first buffer solution tank 1 was filled with the first buffer solution 11, and a platinum wire was used for the first electrode 12.

(Second Buffer Solution Tank 2)

The second buffer solution tank 2 of 70 mm×100 mm in length and breadth and 10 mm in depth was disposed on the board 9. A platinum-plated titanium board of 60 mm×70 mm in length and breadth and 0.5 mm in thickness was disposed as the second electrode 22 on the center of the bottom of the board 9. Two filter papers were put on the titanium board. On the filter papers, acrylic cellulose or PVDF film of 60 mm×60 mm in length and breadth was disposed and was fixed as the adsorption member 6 on the second electrode 22. The second buffer solution tank 2 was filled with the second buffer solution 21.

(Carrying Means of the Sample Separating Section 3)

Carrying means for moving the sample separating section 3 was composed of an X-axis stage (second driving means 72) and a Z-axis stage (first driving means 71) which perform stepping motor driving. The carrying means was disposed on the whole board 9. The X-axis stage 72 was set to be 85 mm in stroke (resolution 1 μm/pulse), and the Z-axis stage 71 was set to be 15 mm in stroke (resolution 1 μm/pulse). The X-axis stage 72 and the Z-axis stage 71 were controlled by a GPIB-connected personal computer via a universal multi-axis stepping motor controller. The sample separating section 3 was fixed on the Z-axis stage 71 via the arm 71b. As shown in FIGS. 2 and 3, the sample separating section 3 was moved in a Z-axis direction (first direction M) so as to make contact with the adsorption member 6.

(Application of Voltage)

The first electrode 12 was connected to a minus side of a high voltage power supply 111, and the second electrode was connected to a plus side of the high voltage power supply 111. The ammeter 114 was disposed between the power supply 111 and the second electrode 22. A voltage was controlled via the data processing section 81 so as to have a constant electric current (10 mA).

(Carrying of the Sample Separating Section 3)

After the application of the voltage to the sample separating section 3, when a sample component which moved fastest reached the end surface of the electrophoresis medium, the second driving means 72 was driven by the driving means control section 83 so as to start carrying of the sample separating section 3 in an X-axis direction (second direction N). Carrying speed was appropriately set and controlled so that the carrying of the separation section 3 stopped right before the end surface of the adsorption member 6 at the time when a sample component which moved slowest was discharged.

### Example 2

### First-Dimension Electrophoresis

### Sample Medium 10

Immobiline immobilized pH gradient isoelectric focusing gel which was cut into a piece of 1 mm×60 mm was used. The sample introduction and the gel swelling were performed, and the electrophoresis was carried out at 3500V for eight hours. Molecular weight markers which were fluorescence-labeled with Cy5 were mixed with the sample.

(Sample Separating Section 3)

A tapered spacer was sandwiched by two board insulators 34 of 60 mm×50 mm in length and breadth and 2 mm in thickness. The sample separating section 3 was filled with polyacrylamide gel as the separation medium 33. The thickness of the gel was 0.2 mm at the exit and 11.0 mm at the entrance. The board insulators 34 holding the separation medium were made of glass or resin (e.g. PMMA (polymethyl methacrylate)) that are transparent in a visible light region for fluorescence imaging. It should be noted that the sample separating section 3 was disposed horizontally.

(First Buffer Solution Tank 1)

The first buffer solution tank 1 of 70 mm×10 mm in length and breadth and 10 mm in depth was disposed on the end of the sample separating section 3 where electrophoresis started. The sample medium 10 having been subjected to first-dimension electrophoresis was equilibrated and was fixed on the top surface of the separation medium 33. The first buffer solution tank 1 was filled with the first buffer solution 11, and a platinum wire was used for the first electrode 12.

(Second Buffer Solution Tank 2, Roll (section for unrolling the adsorption member 72a and section for rolling up the adsorption member 72b))

The second buffer solution tank 2 of 70 mm×30 mm in length and breadth and 10 mm in depth was disposed on the end of the sample separating section 3 where electrophoresis ended. The second buffer solution tank 2 was filled with the second buffer solution 21. As the adsorption member 6, acrylic cellulose or PVDF film was wound around the roll 72a, and was rolled up by the roll 72b via the guide 72c while making contact with the end of the separation medium 33 which faced the second buffer solution tank 2. The second electrode 22 was made of a platinum-plated wire electrode, and pressed the adsorption member 6 from behind on the end of the separation medium 33 which faced the second buffer solution tank 2.

(Application of Voltage)

The first electrode 12 was connected to a minus side of a high voltage power supply 111, and the second electrode was connected to a plus side of the high voltage power supply 111. The ammeter 114 was disposed between the power supply 111 and the second electrode 22. A voltage was controlled via the data processing section 81 so as to have a constant electric current (10 mA).

(Fluorescence Detection Section 92)

The fluorescence detection section 92 was disposed in order to monitor moving velocity of the Cy5 fluorescence-labeled molecular weight marker mixed in the sample. A halogen lamp was used for the light irradiation section 91 in order to excite coloring matters. The whole of the separation medium 33 was irradiated by using a band-pass filter of 620 nm. A fluorescence image was taken in real time by a CCD camera by using a band-pass filter of 680 nm. The moving velocity of the molecular weight marker was calculated from the obtained fluorescence image. A sample component which moved fastest and a sample component which moved slowest were calculated. The roll controlling section 82 was driven and the adsorption member 6 was rolled up when the sample component which moved fastest reached the end surface of an electrophoresis medium. The speed of rolling up was controlled so that the sample component which moved fastest and the sample component which moved slowest were included in an appropriate adsorption (transfer) profile. Further, modulation of the velocity that happened in the process was detected. By adjusting the speed of rolling up in accordance with the modulation, a difference in the adsorption (transfer) pattern was controlled.

With the present invention, separation of a protein by electrophoresis and collection of sample components by the adsorption member can be performed in the same appliance and in a series of operations. Especially, when the present invention includes driving means for changing the relative position between the second opening and the second electrode (or the adsorption member), separation of a protein by electrophoresis and transfer by electroblotting can be performed in the same appliance and in a series of operations. Therefore, the time required for all the steps can be shortened, automation of all the steps can be easily achieved, and reproducibility can be improved.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

With the present invention, it is possible to improve the disadvantage of an electrophoresis device and an electroblotting device. Therefore, the present invention can contribute to the development of the proteome that is vigorously researched. Further, it is possible to activate the market by separately manufacturing and selling the sample separation/adsorption appliance of the present invention and various kinds of members used in the appliance.

1.-17. (canceled)

18. A sample separation/adsorption appliance comprising:
a first buffer solution tank in which a first electrode is to be disposed,
a second buffer solution tank in which a second electrode is to be disposed, and
a sample separating section in which a separation medium is to be contained,
the sample separating section having a first opening which opens into the first buffer solution tank and a second opening which opens into the second buffer solution tank,
the sample separation/adsorption appliance further comprising second electrode fixing means for disposing the second electrode oppositely to the second opening and adsorption member holding means for holding, between the second opening and the second electrode, an adsorption member for adsorbing sample components discharged from the second opening.

19. A sample separation/adsorption appliance comprising:
a first buffer solution tank,
a second buffer solution tank, and
a sample separating section,
the sample separating section having a first opening which opens into the first buffer solution tank and a second opening which opens into the second buffer solution tank and containing a separation medium via which a sample applied from the first opening is separated into individual components towards the second opening,
the sample separation/adsorption appliance further comprising:
a first electrode disposed in the first buffer solution tank,
a second electrode fixed oppositely to the second opening so as to be disposed in the second buffer solution tank, and
an adsorption member holding means for holding, between the second opening and the second electrode, an adsorption member for adsorbing sample components discharged from the second opening.

20. The sample separation/adsorption appliance according to claim 18, further comprising
first driving means for moving the first buffer solution tank in a first direction defined by the first opening and the second opening.

21. The sample separation/adsorption appliance according to claim 18, further comprising
second driving means for changing a relative position between the second opening and the second electrode (or an adsorption member) in a second direction substantially vertical to a first direction defined by the first opening and the second opening.

22. The sample separation/adsorption appliance according to claim 18, wherein
the sample separating section is disposed substantially vertically to a surface of a second buffer solution which fills the second buffer solution tank.

23. The sample separation/adsorption appliance according to claim 18, wherein
the sample separating section is disposed substantially horizontally to a surface of a second buffer solution which fills the second buffer solution tank.

24. The sample separation/adsorption appliance according to claim 18, wherein
the sample separating section is composed of two board insulators and spacers for defining a thickness of the separation medium to be contained between the two board insulators.

25. The sample separation/adsorption appliance according to claim 18, wherein
the sample separating section is tapered from the first opening towards the second opening.

26. The sample separation/adsorption appliance according to claim 18, wherein
the second electrode has a same shape as the second opening and has a same size as the second opening or a smaller size than the second opening.

27. The sample separation/adsorption appliance according to claim 18, wherein
the second electrode has a plane shape and is fixed in the second buffer solution tank.

28. The sample separation/adsorption appliance according to claim 19, wherein
the second electrode is divided into a plurality of stripe-shaped electrodes.

29. The sample separation/adsorption appliance according to claim 18, wherein
the adsorption member has a membrane shape.

30. The sample separation/adsorption appliance according to claim 21, further comprising
a controlling section for temporally controlling a voltage applied across the first electrode and the second electrode or for temporally controlling second driving means.

31. The sample separation/adsorption appliance according to claim 30, wherein
the controlling section controls depending on a current value between the first electrode and the second electrode.

32. The sample separation/adsorption appliance according to claim 18, further comprising
a light irradiation section and a fluorescence detection section.

33. The sample separation/adsorption appliance according to claim 19, further comprising
first driving means for moving the first buffer solution tank in a first direction defined by the first opening and the second opening.

34. The sample separation/adsorption appliance according to claim 19, further comprising
second driving means for changing a relative position between the second opening and the second electrode (or an adsorption member) in a second direction substantially vertical to a first direction defined by the first opening and the second opening.

35. The sample separation/adsorption appliance according to claim 19, wherein
the sample separating section is disposed substantially vertically to a surface of a second buffer solution which fills the second buffer solution tank.

36. The sample separation/adsorption appliance according to claim 19, wherein
the sample separating section is disposed substantially horizontally to a surface of a second buffer solution which fills the second buffer solution tank.

37. The sample separation/adsorption appliance according to claim 19, wherein
the sample separating section is composed of two board insulators and spacers for defining a thickness of the separation medium to be contained between the two board insulators.

38. The sample separation/adsorption appliance according to claim 19, wherein
the sample separating section is tapered from the first opening towards the second opening.

39. The sample separation/adsorption appliance according to claim 19, wherein
the second electrode has a same shape as the second opening and has a same size as the second opening or a smaller size than the second opening.

40. The sample separation/adsorption appliance according to claim 19, wherein
the second electrode has a plane shape and is fixed in the second buffer solution tank.

41. The sample separation/adsorption appliance according to claim 19, wherein
the adsorption member has a membrane shape.

42. The sample separation/adsorption appliance according to claim 34, further comprising
a controlling section for temporally controlling a voltage applied across the first electrode and the second electrode or for temporally controlling second driving means.

43. The sample separation/adsorption appliance according to claim 42, wherein
the controlling section controls depending on a current value between the first electrode and the second electrode.

44. The sample separation/adsorption appliance according to claim 19, further comprising
a light irradiation section and a fluorescence detection section.
